(19) United States
(12) Patent Application Publication
(10) Pub. No.: US 2025/0337330 A1
(43) Pub. Date: Oct. 30, 2025

(54) ULTRA-WIDE INPUT POWER SUPPLY

(71) Applicant: Caterpillar Inc., Peoria, IL (US)

(72) Inventors: Rien W. O’steen, Saint Johns, FL (US); Venkata Ramakrishna Challa, Narasaraopet (IN)

(73) Assignee: Caterpillar Inc., Peoria, IL (US)

(21) Appl. No.: 18/646,243

(22) Filed: Apr. 25, 2024

(51) Int. Cl. H02M 3/335; H02M 1/00; H02M 1/32; H02M 1/36

(52) U.S. Cl. CPC H02M 3/33523; H02M 1/007; H02M 1/32; H02M 1/36; H02M 3/33569

(57) ABSTRACT

A power supply circuit includes a supply input including a positive terminal, a neutral terminal, and a negative terminal, wherein an input voltage is applied to the positive terminal and the negative terminal; a first switching converter circuit referenced to the neutral terminal and having a first converter input coupled to the positive terminal, and a first converter output to produce a first regulated output voltage referenced to an isolated ground electrically isolated from the supply input; a second switching converter circuit having a second converter input coupled to the neutral terminal and the negative bus terminal, and a second switching converter circuit referenced to the negative terminal and having a second converter input coupled to the neutral terminal, and a second converter output to produce a second regulated output voltage referenced to the isolated ground.

### TECHNICAL FIELD

This document relates to high voltage power supplies and in particular to power supply circuit topologies with a very large input voltage range.

### BACKGROUND

Electric large moving non-road work machine (e.g., a wheel loader, a mining truck, etc.) may use power supplies with very high voltages (e.g., greater than a 1000 Volts). Safety and diagnostic monitoring devices for the work machines may have to operate over a wide range of voltages, which can complicate their design. U.S. Pat. No. 10,778,104 relates to a DC-to-DC converter for converting a low voltage DC input to a higher voltage DC output. The DC-to-DC converter can be used for converting energy harvested from low voltage sources.

### SUMMARY OF THE INVENTION

Electric powered large moving work machines use large capacity battery systems that provide energy to electric motors of the work machines. The battery systems provide very high voltage and current when operating. Monitoring devices for the power systems of the work machines may need to monitor voltages from a startup level to a fully powered up level.

An example of a power supply circuit for a monitoring device includes a supply input including a positive terminal, a neutral terminal, and a negative terminal, wherein an input voltage is applied to the positive terminal and the negative terminal; a first switching converter circuit referenced to the neutral terminal and having a first converter input coupled to the positive terminal, and a first converter output to produce a first regulated output voltage referenced to an isolated ground electrically isolated from the supply input; and a second switching converter circuit referenced to the negative terminal and having a second converter input coupled to the neutral terminal, and a second converter output to produce a second regulated output voltage referenced to the isolated ground.

An example of a method of operating a power supply circuit includes: receiving a bus voltage at a positive terminal and a negative terminal of a supply input of the power supply circuit, applying a first input voltage of the positive terminal to a first switching converter circuit referenced to a neutral terminal to produce a first regulated output voltage referenced to an isolated ground isolated from the supply input, and applying a second input voltage of the neutral terminal to a second switching converter circuit to referenced to the negative terminal to produce a second regulated output voltage referenced to the isolated ground.

### BRIEF DESCRIPTION OF THE DRAWINGS

FIG. 1 is an elevation view depicting an example work machine in accordance with this disclosure.

FIG. 2 is a block diagram of a modular battery system in accordance with this disclosure.

FIGS. 3A-3D include a circuit diagram of a power supply circuit in accordance with this disclosure.

FIG. 4 is a flow diagram of an example of a method of operating a power supply circuit in accordance with this disclosure.

### DETAILED DESCRIPTION

Examples according to this disclosure are directed to methods and devices with improved diagnostic circuits for an electric-powered work machine.

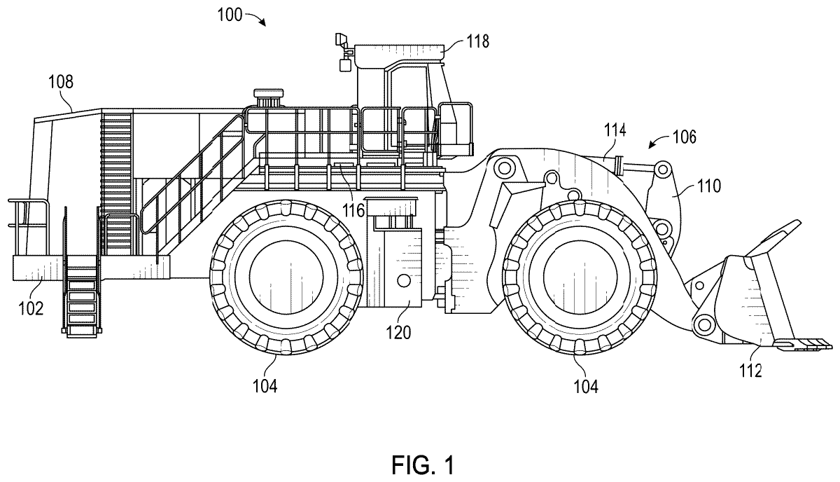

FIG. 1 is an elevation view depicting an example machine 100. In FIG. 1, machine 100 includes frame 102, wheels 104, implement 106, and a speed control system implemented in one or more on-board electronic devices like, for example, an electronic control unit or ECU. Example machine 100 is a wheel loader. In other examples, however, the machine may be other types of machines related to various industries, including, as examples, construction, agriculture, forestry, transportation, material handling, waste management, marine, stationary power, and so on. Accordingly, although some examples are described with reference to a wheel loader machine, examples according to this disclosure are also applicable to other types of machines including graders, scrapers, dozers, excavators, compactors, material haulers like dump trucks, marine vessels, locomotives, along with other example machine types.

Machine 100 includes frame 102 mounted on four wheels 104, although, in other examples, the machine could have more than four wheels. Frame 102 is configured to support and/or mount one or more components of machine 100. For example, machine 100 includes enclosure 108 coupled to frame 102. Enclosure 108 can house, among other components, an electric motor to propel the machine over various terrain via wheels 104. In some examples, multiple electric motors are included in multiple enclosures at multiple locations of the machine 100.

Machine 100 includes implement 106 coupled to the frame 102 through linkage assembly 110, which is configured to be actuated to articulate bucket 112 of implement 106. Bucket 112 of implement 106 may be configured to transfer material such as, soil or debris, from one location to another. Linkage assembly 110 can include one or more cylinders 114 configured to be actuated hydraulically or pneumatically, for example, to articulate bucket 112. For example, linkage assembly 110 can be actuated by cylinders 114 to raise and lower and/or rotate bucket 112 relative to frame 102 of machine 100.

Platform 116 is coupled to frame 102 and provides access to various locations on machine 100 for operational and/or maintenance purposes. Machine 100 also includes an operator cabin 118, which can be open or enclosed and may be accessed via platform 116. Operator cabin 118 may include one or more control devices (not shown) such as, a joystick, a steering wheel, pedals, levers, buttons, switches, among other examples. The control devices are configured to enable the operator to control machine 100 and/or the implement 106. Operator cabin 118 may also include an operator interface such as, a display device, a sound source, a light source, or a combination thereof.

Machine 100 can be used in a variety of industrial, construction, commercial or other applications. Machine 100 can be operated by an operator in operator cabin 118. The operator can, for example, drive machine 100 to and from various locations on a work site and can also pick up and deposit loads of material using bucket 112 of implement 106. By further way of example, both operation by a remotely located operator and autonomous or robotic operation are contemplated. Machine 100 can be used to excavate a portion of a work site by actuating cylinders 114 to articulate bucket 112 via linkage assembly 110 to dig into and remove dirt, rock, sand, etc. from a portion of the work site and deposit this load in another location. Machine 100 can include a battery compartment connected to frame 102 and including a battery system 120. Battery system 120 is electrically coupled to the one or more electric motors of the work machine 100.

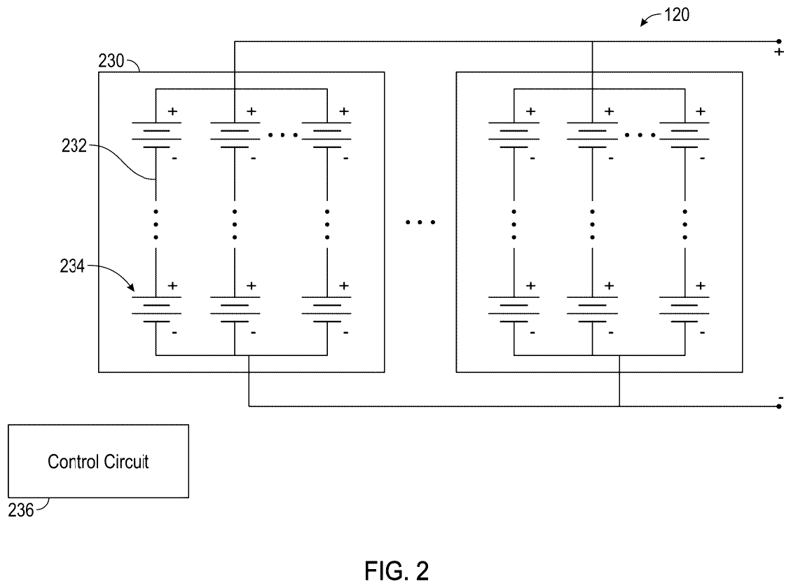

FIG. 2 is a block diagram of a modular battery system. The battery system 120 can be used to provide power to a machine, such as the example machine 100 of FIG. 1. The battery system 120 includes multiple battery packs 230 (e.g., two to eight battery packs) connected to a DC battery bus 236 to provide DC power for the machine. Each battery pack 230 includes multiple battery strings 232 (e.g., two to five battery strings). Each battery string 232 includes multiple large capacity batteries 234 or battery cells connected in series. The parallel connection of the large capacity batteries provides high current (e.g., 500 Amps) to the DC battery bus and the series connection of the batteries provides high voltage (e.g., 1200V) to the DC battery bus 236. The batteries 234 of the battery system are not all brought online at once. Batteries may be brought online individually, at the string level, or the battery pack level to bring the battery system 120 to the high current and the high voltage level.

The electric work machine can include buses in addition to the DC battery bus, e.g., a high voltage traction bus to drive the wheels of the work machine, and a high voltage accessory bus. In an example intended to be illustrative and non-limiting, the battery bus may be 1200V, the traction bus may be 3200V, and accessory bus may be 800V. The additional buses may be decoupled from the DC battery bus through DC-to-DC (DC/DC) converters.

The work machine may include diagnostic devices to monitor elements that power the work machine, such as by monitoring the status of the high voltage DC power buses. Such a diagnostic or monitoring device may need to provide an indication when the voltage on any of the buses is greater than a predetermined threshold (e.g., 50V). For safety reasons, the monitoring devices may have to be powered using the same high voltage bus that it is monitoring. This provides challenges in designing diagnostic systems for the work machines. For instance, a monitor device may need to monitor a DC power bus with a range of zero volts (0V) at startup to a full operating range of 3200V using circuit elements designed for use with a circuit supply of tens of volts.

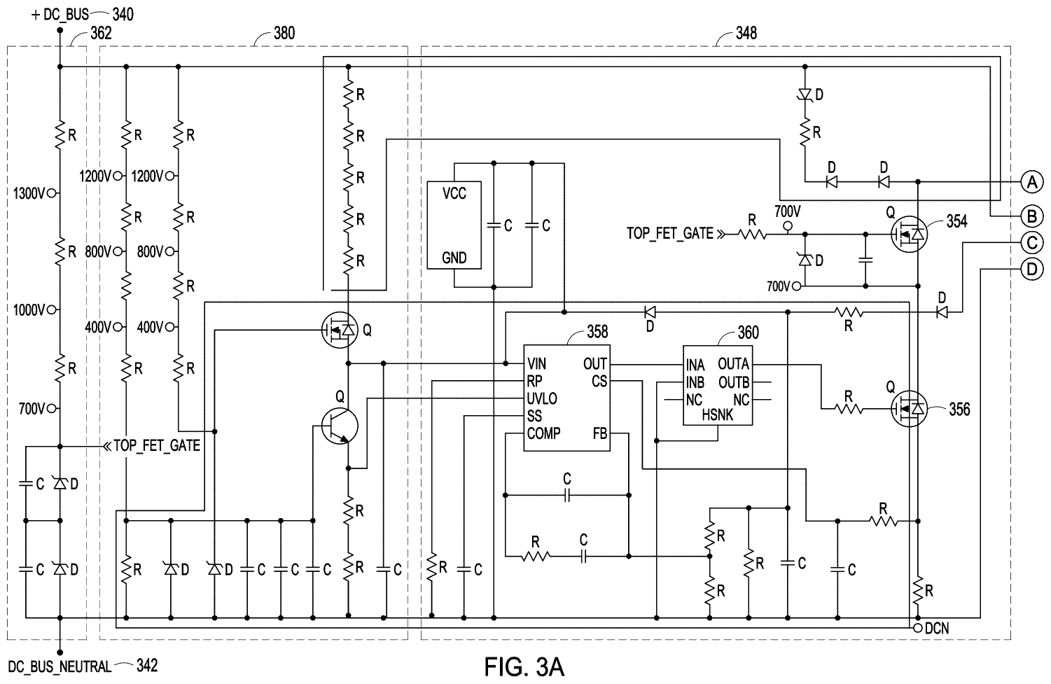

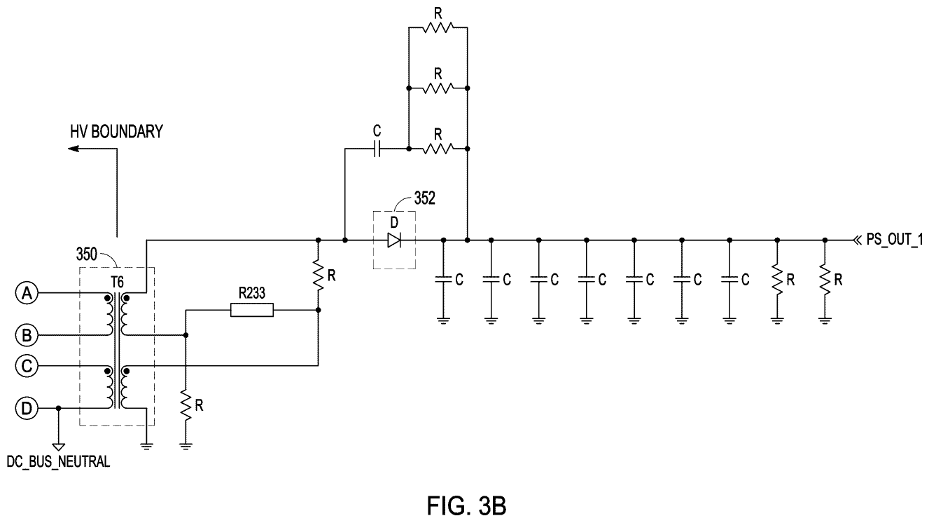

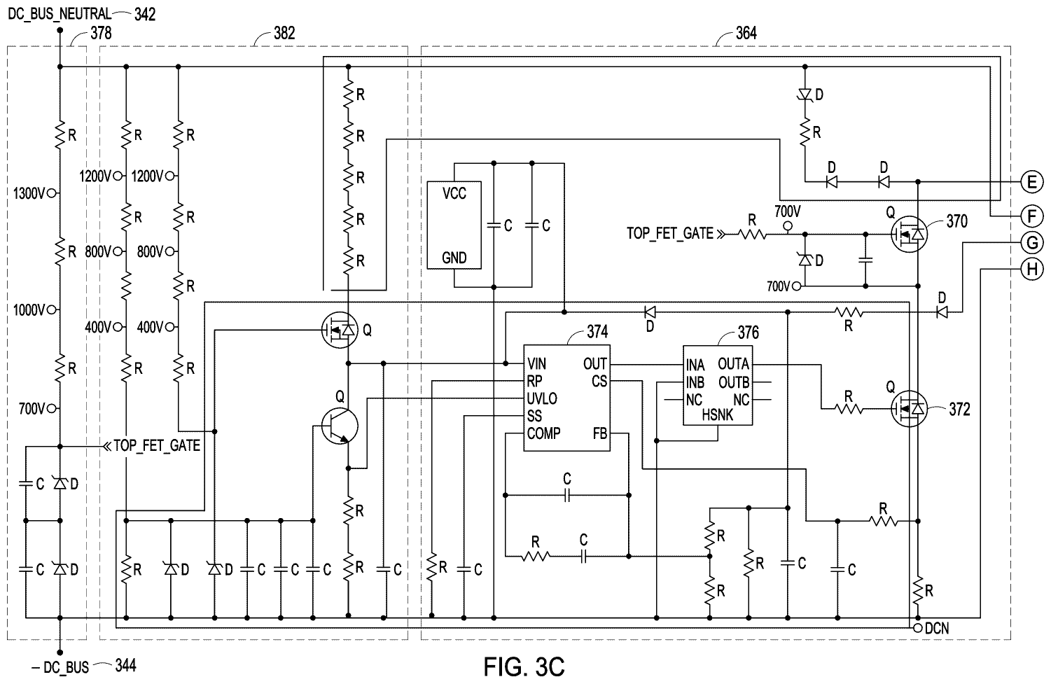

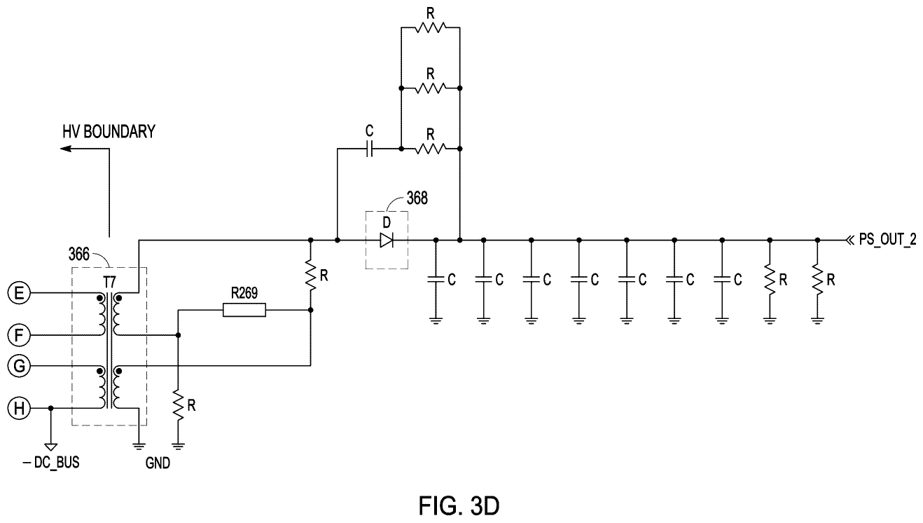

FIGS. 3A-3D are a circuit diagram of a power supply circuit. The power supply circuit has an ultra-wide input range and can be a circuit supply to a monitoring device of an electric work machine. The power supply circuit may be connected to a DC power bus of a work machine. The power supply circuit has a supply input that includes three terminals: a positive terminal 340, a negative terminal 344, and a neutral terminal 342 to form a three-level input. The voltage of the DC power bus is the input voltage to the power supply circuit, and the higher voltage DC bus connection (+DC_BUS) is applied to the positive terminal 340 and the lower voltage DC bus connection (−DC_BUS) is applied to the negative terminal 344 of the supply input.

The three-level input to the power supply circuit is split into two two-level inputs that are applied to two independently functioning switching converter circuits. The outputs of the two switching converter circuits each provide a regulated output for the monitoring device. FIGS. 3A and 3B show a circuit diagram of an example of the first switching converter circuit. The first switching converter circuit in the example of FIGS. 3A and 3B has a flyback converter circuit topology, but the switching converter circuit may have other circuit topologies, e.g., buck converter, buck/boost converter, etc.).

FIG. 3A shows the switching portion 348 of the first switching converter circuit. FIG. 3A shows that the input of the first switching converter circuit is coupled to the positive terminal 340 (+DC_BUS) and the neutral terminal 342 (DC_BUS_NEUTRAL). FIG. 3B shows that the output of the switching portion 348 is provided to the primary side of a transformer 350 that isolates the supply input from the supply output. The primary side of the transformer 350 receives an output from the switching portion 348 that is referenced to the neutral terminal 342. The supply output on the secondary side of the transformer 350 and output diode 352 is a regulated output voltage (PS_OUT_1) referenced to an isolated circuit ground (GND) isolated from the supply input by the transformer 350. The feedback for the switching portion 348 is taken from the transformer 350 to produce the regulated output voltage.

The input voltage to the power supply circuit is converted to a voltage appropriate for the monitoring device. In the example described previously herein, the full range of the DC power bus may be 3200V. Because the input to the power supply circuit is split into two two-level inputs, the input voltage to the first switching converter circuit may be 1600V. The monitoring device powered by the power supply circuit may use a circuit supply of tens of volts (e.g., 10-20V) or less. Because the power supply circuit can accommodate such a high input voltage, the power supply circuit is an ultra-wide input power supply.

Returning to FIG. 3A, the switching portion 348 of the switching converter circuit includes a pair of cascode-connected field effect transistors (cascode FETs) connected to the primary side of the transformer and a pulse width modulation (PWM) circuit. The two cascode FETs include a top FET 354 and a bottom FET 356. The switching of the FETs produces a voltage stepped down from the input voltage at the positive and neutral terminals. The PWM circuit 358 controls switching of the FETs according to the feedback from the transformer 350. As the input rises, the switching duty cycle of the FETs decreases. The switching portion 348 of the switching converter circuit in FIG. 3A includes a gate driver 360 to shorten the turn-on time of the bottom FET 356 to accommodate very short duty cycles (e.g., switching on time of one percent, or duty cycle=1%). Operating the power supply circuit with a very short duty cycle limits power consumption of the power supply circuit at very high input voltages.

As the input to the switching portion 348 rises and the switching controlled by the PWM circuit 358 begins, the switching is performed using the bottom FET 356 and the input voltage is mostly across the bottom FET 356 until the input rises to a specified input threshold voltage level. When the input rises to the specified input threshold voltage level, the top FET 354 contributes to the switching and the input voltage is across both of the top FET 354 and the bottom FET 356. This prevents the drain-to-source voltage (VDS) of the bottom FET 356 from becoming too great. The switching converter circuit in FIG. 3A includes an FET bias circuit 362 to bias the control input of the top FET 356. In the example of FIG. 3A, the FET bias circuit 362 prevents the top FET 354 from contributing to the switching until the input voltage rises to the 700V level.

FIGS. 3C and 3D show a circuit diagram of an example of the second switching converter circuit of the two independently functioning switching converter circuits. The lower of the two-level inputs is applied to the supply input of the second switching converter circuit. The circuit topology of the second switching converter circuit of FIGS. 3C-3D is mostly identical to the circuit topology of the first switching converter circuit of FIGS. 3A-3B.

FIG. 3C shows the switching portion 364 of the second switching converter circuit. FIG. 3C shows that the input of the first switching converter circuit is coupled to the neutral terminal 342 (DC_BUS_NEUTRAL) and the negative terminal 344 (−DC_BUS). FIG. 3D shows that the output of the switching portion 364 is provided to the primary side of another transformer 366 that isolates the supply input from the supply output. The primary side of the transformer 366 receives an output from the switching portion 364 that is referenced to the negative terminal 344. The supply output on the secondary side of the transformer 366 and output diode 352 is a regulated output voltage (PS_OUT_2) referenced to the isolated ground (GND). The feedback for the switching portion 364 is taken from the transformer 366 to produce the regulated output voltage. Returning to FIG. 3C, the switching portion 364 of the second switching converter circuit includes two cascode connected FETs and a PWM circuit 374. A gate driver 376 to drive the control input of the bottom FET 372, and an FET bias circuit 378 connected to the top FET 370.

As explained previously herein, the two switching converter circuits operate independently. The output terminals of the two switching converter circuits (PS_OUT_1, PS_OUT_2) each provide a regulated output voltage to the monitoring device.

According to some examples, the monitoring device is a hazardous voltage indicator for a work machine, and the power supply circuit of FIGS. 3A-3D powers the hazardous voltage indicator. For instance, when the work machine is activated, the DC power bus is brought to the full operating range of the (e.g., 3200V) of the bus. When the DC power bus exceeds a specified hazardous voltage (HV) threshold, the hazardous voltage indicator is activated to provide an indication of hazardous voltage. For example, the hazardous voltage indicator may include an HV lamp circuit and activating the hazardous voltage indicator lights an HV lamp observable by an operator of the machine. Each of the switching converter circuits monitors half of the DC power bus and may provide a regulated output voltage used to power a hazardous voltage indicator, which may be connected to one of the output terminals PS_OUT_1, PS_OUT_2 of the power supply circuit.

The power supply circuit is connected to the DC power bus and provides power to the hazardous voltage indicators when the voltage of the DC power bus reaches a specified a startup threshold voltage level. The first switching converter circuit includes a lockout circuit 380 shown in FIG. 3A, and the second switching converter circuit includes a lockout circuit 382 shown in FIG. 3C. The lockout circuits prevent startup of the PWM circuit of its respective switching converter circuit up to a startup threshold voltage level. Above the startup threshold voltage level, the lockout circuits turn off to enable the PWM circuit of the respective switching converter circuit to startup and provide an output to the hazardous voltage indicators.

Because the DC power bus is split into the two two-level inputs, each of the switching converter circuits prevents startup of the PWM circuit until the input to the switching converter circuit reaches one-half the startup threshold voltage level. As an example, if the startup threshold voltage level is 50V, it is desired for the power supply circuit to activate the hazardous voltage indicator when the DC power bus is 50V. Because the DC power bus is split into the two two-level inputs, the lockout circuits 380, 382 each prevent startup of its corresponding PWM circuit until the input to the switching converter circuit reaches one-half of 50V, or 25V.

After startup each of the switching converter circuits provides a regulated output voltage to activate a hazardous voltage indicator connected to its output terminal, with each of the outputs referenced to the isolated ground. Each of the hazardous voltage indicators correspond to the half of the DC power bus connected to the corresponding switching converter circuit. As explained previously herein, for safety reasons it is desired for the hazardous voltage indicators to be powered by the power source it is monitoring. In the example described herein, the power supply circuit needs to activate at 50V and provide power at 10-20V to the hazardous voltage indicator for an input range of 50V to 3200V. The full range operating voltage is sixty-four times the startup voltage and may be over a hundred times the regulated output voltage provided to the hazardous voltage indicator. Because of the ultra-wide input range, the transformers 350, 366 are designed to provide isolation at the full range voltage level and include high clearance to prevent creep of the interconnect due to the high voltage gradient.

### INDUSTRIAL APPLICABILITY

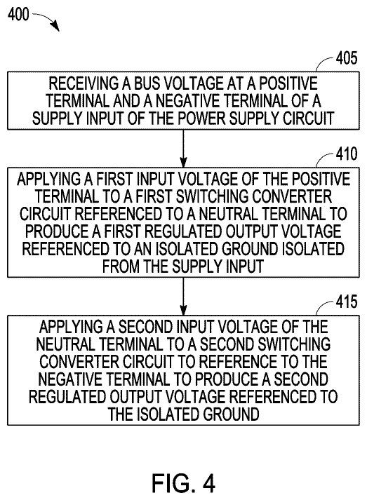

FIG. 4 is a flow diagram of an example of a method 400 of operating a power supply circuit, such as the supply circuit of FIGS. 3A-3D. The power supply circuit provides a regulated output over a large input voltage range.

At block 405, the bus voltage is received at a positive terminal and a negative terminal of a supply input of the power supply circuit. The bus voltage may be the voltage of a DC power bus for an electric work machine.

At block 410, a first input voltage is applied to a first switching converter circuit to produce a first regulated output voltage. The first input voltage is the voltage of the positive terminal. The switching portion of the first switching converter circuit is referenced to a neutral terminal of the power supply circuit. The first regulated output voltage produced by the first switching converter circuit is referenced to an isolated ground that is electrically isolated from the supply input. At block 415, a second input voltage is applied to a second switching converter circuit to produce a second regulated output voltage. The second input voltage is the voltage of the neutral terminal. The switching portion of the second switching converter circuit is referenced to the negative terminal of the power supply circuit. The second regulated output voltage produced by the second switching converter circuit is referenced to the isolated ground.

Blocks 410 and 415 show that the full range input voltage is split between two independently functioning switching converter circuits. The approach can be expanded to split the input voltage among more than two independently functioning switching converter circuits (e.g., three or four two independently functioning switching converter circuits) with multiple terminals between the positive terminal and the negative terminal. A regulated supply output voltage is produced by each of the first switching converter circuit and the second switching converter circuit. The regulated output voltages are produced at output terminals of power supply circuit.

Monitoring devices for the DC power bus can be powered by connecting the devices to the output terminals. In some examples, the startup of the switching converter circuits is prevented or locked out until the voltage of the DC power bus reaches a specified startup threshold voltage. In certain examples, the specified startup threshold voltage is a high voltage detection threshold voltage level. The monitoring device powered by the output voltage of the first switching converter circuit can provide an indication of hazardous voltage for the top half of the DC power bus (e.g., a hazardous voltage between the positive terminal and the neutral terminal of the bus). The monitoring device powered by the output voltage of the second switching converter circuit can provide an indication of hazardous voltage for the bottom half of the DC power bus (e.g., a hazardous voltage between the neutral terminal and the negative terminal of the bus).

In certain examples, the input voltage to the power supply circuit is more than fifty times the regulated output produced at the output terminals. In certain examples, the input voltage is more than one hundred times the regulated output produced at the output terminals. The switching converter circuits may use PWM of switching circuit elements (e.g., switching power FETs) to produce a regulated output voltage. The switching converter circuits include cascode connected switching circuit elements, and the input voltage is applied across the cascode connected switching circuit elements to prevent the voltage across any one of the switching circuit elements from becoming too great.

Other than the electrical isolation devices, the techniques described herein meet the safety requirements using available integrated circuit elements. This avoids the need for developing custom integrated circuit devices to handle the ultra-wide input range.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

The above detailed description is intended to be illustrative, and not restrictive. The scope of the disclosure should, therefore, be determined with references to the appended claims, along with the full scope of equivalents to which such claims are entitled.

What is claimed is:

1. A power supply circuit comprising:
a supply input including a positive terminal, a neutral terminal, and a negative terminal, wherein an input voltage is applied to the positive terminal and the negative terminal;
a first switching converter circuit referenced to the neutral terminal and having a first converter input coupled to the positive terminal, and a first converter output to produce a first regulated output voltage referenced to an isolated ground electrically isolated from the supply input; and
a second switching converter circuit referenced to the negative terminal and having a second converter input coupled to the neutral terminal, and a second converter output to produce a second regulated output voltage referenced to the isolated ground.

2. The power supply circuit of claim 1, wherein the first and second switching converter circuits produce a regulated output voltage using a supply input voltage range that is more than fifty times greater than the regulated output voltage.

3. The power supply circuit of claim 1, including:
a first lockout circuit and a second lockout circuit;
wherein the first switching converter circuit includes the first lockout circuit and a first pulse width modulation (PWM) circuit to control switching of the first switching converter circuit;
wherein the second switching converter circuit includes the second lockout circuit and a second PWM circuit to control switching of the second switching converter circuit; and
wherein the first and second lockout circuits are configured to prevent startup of the PWM circuit of its respective switching converter circuit up to a startup threshold voltage level, above which the lockout circuit of the respective switching converter circuit turns off to enable the PWM circuit of the respective switching converter circuit to startup.

4. The power supply circuit of claim 1, wherein the first and second switching converter circuits each produce a regulated output voltage from an input voltage ranging from a startup threshold voltage to a full range voltage and each switching converter circuit includes:
a transformer including a primary side coupled to the switching circuit and a secondary side;
two cascode-connected field effect transistors (cascode FETs) connected to the primary side of the transformer, wherein the two cascode FETs include a top FET and a bottom FET; and
wherein the top FET is biased so that the bottom FET switches the input voltage when the input voltage is between the startup threshold voltage and one-half of a full range voltage, and both the top FET and bottom FET switch the input voltage when the input voltage is from one-half of the full range voltage to the full range voltage.

5. The power supply circuit of claim 4, including:
an FET bias circuit configured to bias the top FET circuit to turn on when the input voltage is between the startup threshold voltage and one-half of a full range voltage.

6. The power supply circuit of claim 1, including:
a first transformer to electrically isolate the first converter output from the positive terminal;
a second transformer to electrically isolate the second converter output from the neutral terminal; and
wherein the first and second transformers provide isolation of a secondary circuit side from a primary circuit side having an input range that is greater than fifty times the regulated output voltage of the respective switching converter circuit.

7. The power supply circuit of claim 1,
wherein the first and second switching converter circuits have a flyback converter circuit topology; and
wherein each of the flyback converter circuits is configured to produce a regulated output voltage from an input voltage range that includes the regulated output voltage and a full range voltage that is greater than fifty times the regulated output voltage.

8. A method of operating a power supply circuit, the method comprising:
receiving a bus voltage at a positive terminal and a negative terminal of a supply input of the power supply circuit;
applying a first input voltage of the positive terminal to a first switching converter circuit referenced to a neutral terminal to produce a first regulated output voltage referenced to an isolated ground isolated from the supply input; and
applying a second input voltage of the neutral terminal to a second switching converter circuit to referenced to the negative terminal to produce a second regulated output voltage referenced to the isolated ground.

9. The method of claim 8,
wherein the applying the first input voltage includes applying a first input voltage to the first switching converter circuit that is included in a voltage range from the first regulated output voltage to a voltage more than fifty times greater than the first regulated output voltage; and
wherein the applying the second input voltage includes applying a second input voltage to the second switching converter circuit that is included in a voltage range from the second regulated output voltage to a voltage more than fifty times greater than the second regulated output voltage.

10. The method of claim 8, including:
preventing startup of the first switching converter circuit until the first input voltage reaches a startup threshold voltage; and
preventing startup of the second switching converter circuit until the second input voltage reaches the startup threshold voltage.

11. The method of claim 8, including:
starting the first and second switching converter circuits when the bus voltage exceeds a high voltage detection threshold voltage level; and
activating an indicator circuit operatively coupled to the power supply circuit when the bus voltage exceeds a high voltage detection threshold voltage level.

12. The method of claim 8, including:
switching a bottom field effect transistor (FET) of a pair of cascode connected FETs of a switching converter circuit of the first and second switching converter circuits to produce a regulated voltage when the bus voltage is less than one half of a full range voltage level of the bus voltage; and
switching the bottom FET and a top FET of the pair of cascode connected FETs to produce the regulated voltage when the bus voltage is greater than one half of the full range voltage level of the bus voltage.

13. A diagnostic system for an electric work machine, the system comprising:
a direct current (DC) power bus to provide power to the electric work machine, the DC power bus including a positive DC bus connection and a negative DC bus connection;
a diagnostic circuit configured to monitor a bus voltage of the DC power bus, the diagnostic circuit including:
a power supply circuit including:
a supply input including a positive terminal operatively coupled to the positive DC bus connection, a negative terminal coupled to the negative DC bus connection, and a neutral terminal;
a first switching converter circuit referenced to the neutral terminal, and having a first converter input coupled to the positive bus terminal and a first converter output to produce a first regulated output voltage referenced to an isolated ground electrically isolated from the supply input; and
a second switching converter circuit referenced to the negative terminal, and having a second converter input coupled to the neutral terminal and a second converter output to produce a second regulated output voltage referenced to the isolated ground.

14. The system of claim 13,
wherein the diagnostic circuit includes a first indicator circuit and a second indicator circuit; and
wherein the first converter circuit produces a first regulated output for the first indicator circuit, and the second converter circuit produces a second regulated output for the second indicator circuit.

15. The system of claim 14,
wherein a voltage on the DC power bus is a DC operating voltage of the electric work machine; and
wherein the first and second indicator circuits include a lamp circuit, and the power supply circuit activates the lamp circuits when the DC operating voltage of the electric work machine exceeds a specified threshold voltage level.

16. The system of claim 13, wherein the power supply circuit includes:
a first transformer to electrically isolate the first converter output from the positive bus terminal;
a second transformer to electrically isolate the second converter circuit from the neutral bus terminal; and
wherein an input range of the DC operating voltage is from the first and second regulated output voltages to a full range voltage greater than fifty times the regulated output voltages.

17. The system of claim 13,
wherein the first switching converter circuit includes a first lockout circuit and a first pulse width modulation (PWM) circuit to control switching of the first switching converter circuit;
wherein the second switching converter circuit includes a second lockout circuit and a second PWM circuit to control switching of the second switching converter circuit; and
wherein the first and second lockout circuits are configured to prevent startup of a corresponding PWM circuit until a voltage on the DC power bus increases to a startup threshold voltage level.

18. The system of claim 17, wherein the startup threshold voltage level is a high voltage detection threshold level, and the supply output activates the indicator circuit when the voltage on the DC power bus increases to the high voltage detection threshold level.

19. The system of claim 13, wherein the first and switching converter circuits each produce a regulated output voltage from an input voltage ranging from a startup threshold voltage to a full range voltage and each include:
a transformer including a primary side coupled to the switching circuit and a secondary side;
two cascode-connected field effect transistors (cascode FETs) connected to the primary side of the transformer, wherein the two cascode FETs include a top FET and a bottom FET; and
an FET bias circuit configured to bias the top FET so that the bottom FET switches the input voltage when the input voltage is between the startup threshold voltage and one-half of a full range voltage, and both the top FET and bottom FET switch the input voltage when the input voltage is from one-half of the full range voltage to the full range voltage.

20. The system of claim 13,
wherein the first and second switching converter circuits have a flyback converter circuit topology; and
wherein each of the flyback converter circuits is configured to produce a regulated output voltage from a voltage level of the DC power bus that is in a range of the first and second regulated output voltages to a voltage greater than fifty times the first and second regulated output voltages.
